(19) United States
(12) Patent Application Publication
(10) Pub. No.: US 2026/0230368 A1
(43) Pub. Date: Aug. 6, 2026

(54) INTERFEROMETRIC PAM MODULATION

(71) Applicant: MACOM Technology Solutions Holdings, Inc., Lowell, MA (US)

(72) Inventor: Ronald Thomas Logan, JR., Tobyhanna, PA (US)

(21) Appl. No.: 19/531,108

(22) Filed: Feb. 5, 2026

Related U.S. Application Data
(60) Provisional application No. 63/754,277, filed on Feb. 5, 2025.
(60) Provisional application No. 63/884,588, filed on Sep. 19, 2025.

(51) Int. Cl. H04L 27/36

(52) U.S. Cl. CPC H04L 27/362

(57) ABSTRACT

Interferometric modulators are described, including modulators capable of PAM modulation. An example interferometric modulator includes a generator configured to generate a carrier wave, a modulator coupled to the generator and having a first modulator arm and a second modulator arm, and a driver. The driver can be configured to generate a first bias control signal for phase modulation of the carrier wave in the first modulator arm based on a more significant bit of a data signal and to generate a second bias control signal for modulation of the carrier wave in the second modulator arm based on a less significant bit of the data signal. The interferometric modulators described herein can be designed to implement a number of different transfer functions based on different types of phase shifts, effective path lengthening, or effective path shortening in the first and second modulator arms.

### CROSS-REFERENCE TO RELATED APPLICATIONS

This application claims the benefit of and priority to U.S. Provisional Application No. 63/754,277, filed Feb. 5, 2025, titled “COHERENT INTERFERENCE PAM-4 MODULATION” and U.S. Provisional Application No. 63/884,588, filed Sep. 19, 2025, titled “INTERFEROMETRIC PAM-4 MODULATION,” the entire contents of both of which applications are hereby incorporated herein by reference.

### BACKGROUND

In the context of data communications, modulation refers to a process in which information is encoded onto a carrier wave for transmission of the information. Information, in analog, digital, and other formats can be encoded or imparted onto an electromagnetic wave by altering the amplitude, frequency, phase, or other characteristics of the wave. Information can be modulated onto carrier waves having different frequencies or wavelengths in the electromagnetic spectrum, including waves in the radio frequency (RF), microwave, infrared, visible light, and other spectrums. RF modulation, as one example, is relied upon for transmitting information using carrier waves in the RF spectrum. Modulators are relied upon in a range of applications and industries, including broadcasting, wired and wireless data communication, networks, and radar and sensing systems, among others.

A wave can be modulated in a variety of ways based on analog or digital inputs or input signals. Example modulation formats or approaches include amplitude modulation (AM), frequency modulation (FM), and phase modulation (PM). The AM, FM, and PM terms are commonly used in the context of continuous, analog input signals. For digital input signals, amplitude shift keying (ASK), frequency shift keying (FSK), and phase shift keying (PSK) are similar to AM, FM, and PM, respectively, but are commonly used in the context of digital signals. The amplitude of the carrier wave is modified based on the input signal in AM and ASK, the frequency of the carrier wave is modified based on the input signal in FM and FSK, and the phase of the carrier wave is modified based on the input signal in PM and PSK. Other extensions and variations of the example modulation techniques mentioned above are known, such as on-off keying (OOK), pulse amplitude modulation (PAM), quadrature phase shift keying (QPSK), and quadrature amplitude modulation (QAM).

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

An example modulator system includes a generator configured to generate a carrier wave, a modulator coupled to the generator and comprising a first modulator arm and a second modulator arm, and a driver. The driver is configured to generate a first bias control signal for phase modulation of the carrier wave in the first modulator arm based on a more significant bit of a data signal and generate a second bias control signal for modulation of the carrier wave in the second modulator arm based on a less significant bit of the data signal. The modulator system can be configured to modulate the carrier wave for PAM-4 modulation, and other PAM modulation schemes can be implemented.

In one aspect, the driver can include a first driver configured to generate the first bias control signal for modulation of the carrier wave in the first modulator arm based on the more significant bit of a data signal and a second driver configured to generate the second bias control signal for modulation of the carrier wave in the second modulator arm based on the less significant bit of the data signal. In other aspects, a gain of the second driver can be a fraction of a gain of the first driver. A gain of the second driver can be ⅓ of a gain of the first driver.

In one example, the modulator can include a first phase shifter in the first modulator arm and a second phase shifter in the second modulator arm. In one implementation, the modulator includes an optical modulator, the first modulator arm and the second modulator arm include materials capable of altering refractive indexes based on changing electric fields, and an electric field induced by the first phase shifter based on the first bias control signal is co-linear and in a same direction as an electric field induced by the second phase shifter based on the second bias control signal. In another implementation, an electric field induced by the first phase shifter based on the first bias control signal is in a different direction as compared to an electric field induced by the second phase shifter based on the second bias control signal.

In other cases, the modulator is embodied as a radio frequency (RF) modulator, the first modulator arm and the second modulator arm include a pair of parallel-extending microstrip transmission lines, and the first phase shifter and the second phase shifter have a same polarity. In another implementation, the first phase shifter and the second phase shifter have different polarities.

Another example modulator system includes a generator configured to generate a carrier wave, a modulator coupled to the generator and including a first modulator arm and a second modulator arm, a first driver that receives a more significant bit of a data signal and is configured to generate a first bias control signal for phase modulation of the carrier wave in the first modulator arm, and a second driver that receives a less significant bit of the data signal and is configured to generate a second bias control signal for phase modulation of the carrier wave in the second modulator arm. A gain of the second driver can be a fraction of a gain of the first driver.

In one aspect, the modulator includes a first phase shifter in the first modulator arm and a second phase shifter in the second modulator arm. In one implementation, the modulator is embodied as an optical modulator, the first modulator arm and the second modulator arm include materials capable of altering refractive indexes based on changing electric fields, the first phase shifter includes a first electrode positioned along the first modulator arm, and the second phase shifter includes a second electrode positioned along the second modulator arm. An electric field induced by the first phase shifter based on the first bias control signal can be co-linear and in a same direction as an electric field induced by the second phase shifter based on the second bias control signal. In another case, an electric field induced by the first phase shifter based on the first bias control signal can be in a different direction as compared to an electric field induced by the second phase shifter based on the second bias control signal.

In another implementation, the modulator is embodied as an RF modulator, the first modulator arm and the second modulator arm include a pair of parallel-extending microstrip transmission lines, the first phase shifter includes at least one first switching device having a variable capacitance electrically coupled along the first modulator arm, and second phase shifter comprises at least one second switching device having a variable capacitance electrically coupled along the second modulator arm.

Another example modulator system includes a generator configured to generate a carrier wave, a modulator coupled to the generator and including a first modulator arm and a second modulator arm. The carrier wave is phase shifted in the first modulator arm based on a more significant bit of a data signal, and the carrier wave is phase shifted in the second modulator arm based on a less significant bit of a data signal. In one aspect, a phase shift for a logic true of the more significant bit in the first modulator arm is greater than a phase shift for a logic true of the less significant bit in the second modulator arm. A phase shift for a logic true of the less significant bit in the second modulator arm can be ⅓ of a phase shift for a logic true of the more significant bit in the first modulator arm.

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1 illustrates an example modulation system according to various embodiments described herein.

FIG. 2 illustrates an example transfer function of output power versus relative phase shift for the modulation system shown in FIG. 1 according to various embodiments described herein.

FIG. 3 illustrates another example modulation system according to various embodiments described herein.

FIG. 4 illustrates an example optical modulation system according to various embodiments described herein.

FIG. 5 illustrates an example transfer function of output power versus relative phase shift for the optical modulation system shown in FIG. 4 according to various embodiments described herein.

FIG. 6 illustrates another example transfer function of output power versus relative phase shift for the optical modulation system shown in FIG. 4 according to various embodiments described herein.

FIG. 7 illustrates another example optical modulation system according to various embodiments described herein.

FIG. 8 illustrates an example transfer function of output power versus relative phase shift for the optical modulation system shown in FIG. 7 according to various embodiments described herein.

FIG. 9 illustrates an example radio frequency modulation system according to various embodiments described herein.

### DETAILED DESCRIPTION

Modulators are relied upon in a range of applications and systems, including wired, optical, and wireless data communications, radar and sensing systems, and other systems. New types of modulation systems and modulators are needed, particularly those capable of higher bandwidth communications, as new applications and use cases continue to call for higher data rates. A range of factors should be considered in the design of new modulation systems and modulators, such as bandwidth requirements, detection technique, communications mediums (e.g., copper wires, free air, optical fibers, metal or dielectric waveguides, etc.), distance of communications, costs, and other factors. A number of tradeoffs are often balanced in the design of modulation systems.

Modulators are used to impress or encode data onto carrier waves. As the needs for higher data rates continues to increase, the bandwidth requirements for modulators and detectors have also increased. More advanced, multi-level modulation schemes, such as pulse amplitude modulation (PAM), 4-level PAM (PAM-4), and higher-order PAM schemes, have been introduced into modulation systems to facilitate higher data rates. The transmission of data using PAM-4 modulation, for example, facilitates higher data rates by using four distinct levels to represent two bits of information per symbol. The advantage of the PAM-4 modulation format is that each level represents two bits of information, so the symbol rate, and hence the bandwidth, required to transmit a given number of bits is reduced by a factor of two.

In the context outlined above, interferometric modulation systems for PAM and other encoding techniques are described. An example interferometric modulator includes a generator configured to generate a carrier wave, a modulator coupled to the generator and having a first modulator arm and a second modulator arm, and a driver. The driver can be configured to generate a first bias control signal for phase modulation of the carrier wave in the first modulator arm based on a more significant bit of a data signal and to generate a second bias control signal for modulation of the carrier wave in the second modulator arm based on a less significant bit of the data signal. The interferometric modulators described herein can be designed to implement a number of different transfer functions based on different types of phase shifts, effective path lengthening, or effective path shortening in the first and second modulator arms.

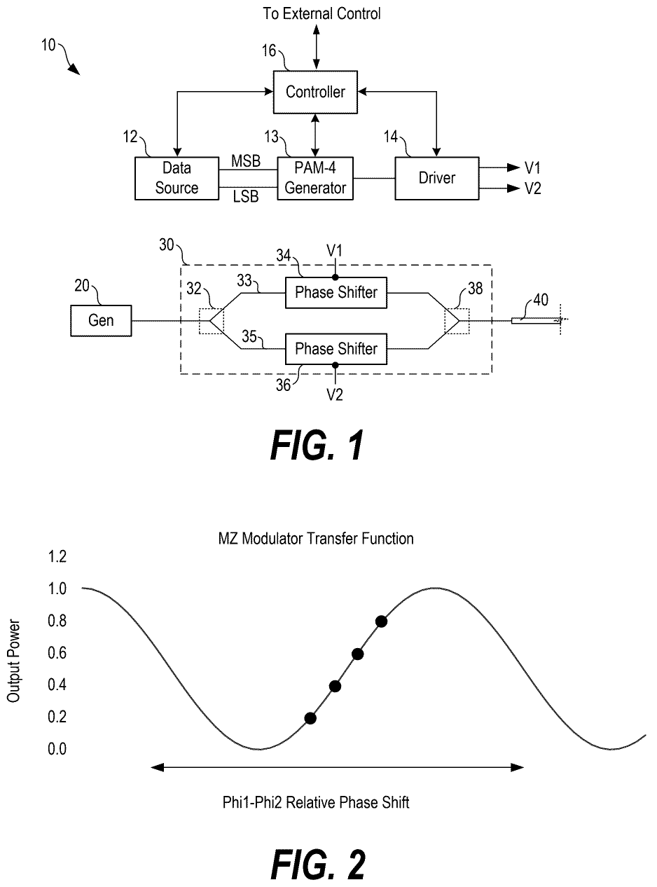

Turning to the drawings, FIG. 1 illustrates an example modulation system 10 according to various embodiments described herein. The modulation system 10 is presented as a representative example of a modulation system according to certain aspects of the embodiments. The modulation system 10 includes a data source 12, a driver 14, a PAM-4 waveform generator 13, a controller 16, a generator 20, a modulator 30, and a communications medium 40, among possibly other components. The modulator 30 includes a splitter 32, a first modulator arm 33 with phase shifter 34, a second modulator arm 35 with phase shifter 36, and a combiner 38, among possibly other components.

The data source 12 can be embodied as any type and format of data or information stored in one or more memory devices, communicated over one or more data communication channels, and combinations thereof. In the example shown, the output from the data source 12 is organized into groups of two (2) bits, including a more significant bit (MSB) and a less significant bit (LSB). The output from the data source 12 is provided as an input to the PAM-4 waveform generator 13.

The PAM-4 waveform generator 13 is configured to generate a 4-level electrical signal for PAM-4 encoding or modulation, based on the MSB and LSB bits from the data source 12. In that sense, the PAM-4 waveform generator 13 is configured to operate as a type of analog-to-digital-converter (ADC), which converts the MSB and LSB digital values into an analog output having one of four (4) electric potentials over time. Thus, the PAM-4 waveform generator 13 can include an array of transistor-resistor circuits, which may be stacked in some cases, as one example.

The driver 14 can be embodied as driver circuitry configured to generate one or more bias control signals for driving and controlling the operation of the modulator 30 based on the output from the PAM-4 waveform generator 13. The driver 14 generates first and second bias control signals V1 and V2 in the example shown in FIG. 1. The bias control signals V1 and V2 are provided as inputs to the modulator 30. More particularly, the bias control signals V1 and V2 are provided as inputs, respectively, to the phase shifter 34 of the first modulator arm 33 and to the phase shifter 36 of the second modulator arm 35.

The controller 16 can be configured to control the operations of the modulator 30, in connection with the data source 12 and the driver 14, to modulate the carrier wave provided from the generator 20. The controller 16 can also be communicatively coupled to an external system computer or controller for status reporting, error reporting, and the communication of other data and control signals. The gain, equalization, and other parameters of the modulation system 10 can thus be monitored and optimized based on external system control in some cases.

The generator 20 is configured to generate an electromagnetic wave, as a type of carrier wave, for modulation with data by the modulator 30. The generator 20 can generate an electromagnetic wave in the RF, microwave, infrared, or visible spectrums. The generator 20 is capable of generating a coherent carrier wave in preferred embodiments. The generator 20 can be configured to generate a carrier wave at a continuous (e.g., static over time) level of power and at a substantially fixed frequency or wavelength and phase over time, although the generator 20 can also generate a carrier wave at a varying level of power, frequency or wavelength, and phase over time in some implementations.

The modulator 30 includes a splitter 32, a first modulator arm 33 with phase shifter 34, a second modulator arm 35 with phase shifter 36, and a combiner 38 in the example shown. The modulator 30 is configured to modulate the carrier wave provided from the generator 20, over time, through interferometry based on the bias control signals V1 and V2 generated by the driver 14. The modulator 30 operates based on the principle of interference and relies upon phase shifts imparted by the phase shifters 34 and 36 to modulate the carrier wave provided from the generator 20. The output of the modulator 30 is provided to the communications medium 40, which can be free space, a copper cable, a fiber optic cable, or another medium.

In the modulator 30, the power of the carrier wave provided from the generator 20 is split by the splitter 32 and directed into the first modulator arm 33 and the second modulator arm 35. The wave in the first modulator arm 33 is subjected to a phase shift by the phase shifter 34 based on the first bias control signal V1, and wave in the second modulator arm 35 is subjected to a phase shift by the phase shifter 36 based on the second bias control signal V2. The phase shifters 34 and 36 impart phase shifts or, in effect, different path lengths on the waves that travel through the modulator arms 33 and 35, respectively, based on the bias control signals V1 and V2. Phase differences introduced in the modulator arms 33 and 35 by the phase shifters 34 and 36 result in constructive or destructive interference in the output of the combiner 38, resulting in modulation of the carrier wave input to the modulator 30. Thus, the modulator 30 generates a modulated carrier wave output and provides the modulated carrier wave output to the communications medium 40.

As noted above, the modulator system 10 can generate PAM-4 symbols using the modulator 30, based on the bias control signals V1 and V2 generated by the driver 14 and the data from the data source 12. In the electrical domain, such as in the electrical domain of the data source 12, the driver 14, and the controller 16, PAM-4 signals are generated by organizing the data in the data source 12 into pairs of data bits, with each pair of data bits including a most significant bit (MSB) and a least significant bit (LSB). Two types of coding schemes are commonly used for encoding PAM-4 signals, including gray-code and non-gray-code coding schemes. Gray coding can be helpful to manage the swing between transitions, reduce bandwidth issues, and for other advantages.

An example of the PAM-4 non-gray-code coding scheme, gray-code coding scheme, MSB, LSB, and relative output levels are shown in Table 1 below. For gray-code, the MSB represents full-scale (on-off) modulation. The LSB is scaled down by ⅓ of the MSB signal amplitude and is subtracted from the MSB “1” amplitude or added to the MSB “0” amplitude, resulting in four distinct relative output levels that each represent a combination of two bits (00, 01, 11, and 10).

TABLE 1
PAM-4 Non-Gray-Code and Gray-Code Relative
Outputs for MSB/LSB Combinations

| | | PAM-4 |
|---|---|---|
| Non-Gray Code | Gray Code | Relative |

| MSB | LSB | MSB | LSB | Output |
|---|---|---|---|---|
| 1 | 1 | 1 | 0 | 1 |
| 1 | 0 | 1 | 1 | 2/3 |
| 0 | 1 | 0 | 1 | 1/3 |
| 0 | 0 | 0 | 0 | 0 |

In the modulation system 10, one or more of the PAM-4 waveform generator 13, the driver 14, and the controller 16 can include specialized circuitry to generate the multi-level bias control signals V1 and V2 for the generation of the PAM-4 output signal from the modulator 30. The PAM-4 waveform generator 13, driver 14, and controller 16 can include relatively complex integrated circuits to generate precise voltage levels and waveforms required for PAM-4 modulation. The driver 14 may include predistortion circuitry to compensate for the non-linearity of the voltage-to-optical output power response of the modulator 30. It may also be necessary for the driver 14 to be highly linear in operation, in order to preserve the integrity of the PAM-4 signal. Overall, the PAM-4 waveform generator 13, driver 14, and controller 16 can include a range of relatively complicated and costly circuitry to preserve the signal integrity of the PAM-4 modulation signal.

FIG. 2 illustrates an example transfer function of output power versus relative phase shift for the optical modulator 10 shown in FIG. 1. For PAM-4, the bias control signals V1 and V2 from the driver 14 can be applied as a differential drive signal with differential voltages to electrodes of the phase shifters 34 and 36. Application of the bias control signals results in a four-level optical output according to the example optical transfer characteristic shown in FIG. 2, where the four different optical levels for PAM-4 are indicated as the four dots on the raised-cosine transfer characteristic.

Other types of modulators for PAM-4 and related encoding techniques are also described herein. The modulators are configured to directly accept two-level MSB and LSB data bits and generate a PAM-4 modulation output signal, without the need for complex PAM-4 waveform-generation circuitry and the attendant power consumption and cost. The modulators can more directly modulate a carrier wave with PAM-4 encoding based on the simultaneous application of a first two-level (i.e., “1” and “0”) MSB data signal and a second two-level LSB data signal. The approaches described herein eliminate the need to generate a multi-level PAM-4 electrical signal, such as that generated by the PAM-4 waveform generator 13, reduce the requirements for complex and highly linear drive amplifiers, and offer other benefits.

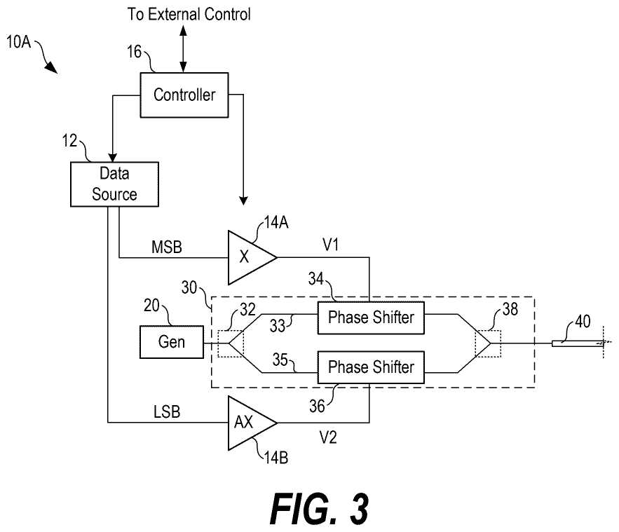

FIG. 3 illustrates another example modulation system 10A according to various embodiments described herein. The modulation system 10A is a representative example of an interferometric modulation system according to the embodiments described herein. The modulation system 10A is a type of a generalized implementation of the optical modulation systems 10B and 10C and the RF modulation system 10D described below. The modulation system 10A can include one or more additional components that are not shown in FIG. 3 in some cases. The modulation system 10A can also omit one or more of the components shown in FIG. 3 in other cases, and variations on the structure of the modulation system 10A are within the scope of the embodiments.

The modulation system 10A includes the data source 12, a first or MSB driver 14A (also “driver 14A”), a second or LSB driver 14B (also “driver 14B”), the controller 16, the generator 20, the modulator 30, and the communications medium 40, among possibly other components. The modulator 30 includes the splitter 32, the first modulator arm 33 with phase shifter 34, the second modulator arm 35 with phase shifter 36, and the combiner 38, among possibly other components.

The data source 12 can be embodied as any type and format of data or information stored in one or more memory devices, communicated over one or more data communication channels, and combinations thereof. The data of the data source 12 can be converted from analog format to digital format, if needed, and the data source 12 can include one or more ADCs, digital-to-analog converters (DACs), memory devices, and other data storage and conversion components. The data of the data source 12 can also be organized in any suitable unit of digital information, such as in groups of two (2) bits, groups of four (4) bits (i.e., nibbles), groups of eight (8) bits (i.e., bytes), or other suitable units. Any given unit of digital information of the data source 12 can thus include one or more less-significant bits and one or more more-significant bits. In the example shown, the output from the data source 12 is organized into groups of two (2) bits, including an MSB and an LSB. The MSB from the data source 12 is provided as an input to the driver 14A, and the LSB from the data source 12 is provided as an input to the driver 14B.

Individual MSBs and LSBs from the data source 12 can be provided as inputs to the drivers 14A and 14B at any suitable baud (e.g., symbol) or data rate over time. The rate at which the data is provided from the data source 12 to the drivers 14A and 14B can be static or vary over time. In some cases, the controller 16 can be configured to alter the rate at which data is provided from the data source 12 to the drivers 14A and 14B over time. The controller 16 can also be configured to adjust the operating and output frequency of the generator 20. The controller 16 can alter the data rate from the data source 12, the operating frequency of the generator 20, or both to achieve a dynamically adjustable baud or symbol rate for the modulation system 10A. The controller 16 can adjust the baud or symbol rate for the modulation system 10A based on channel conditions on the communications medium 40, performance targets, power constraints, or other factors and targets.

In the modulation system 10A, two-level (e.g., “1” or “0”) MSB and LSB electrical data is provided to the drivers 14A and 14B, separately, for each PAM-4 symbol from the data source 12. Thus, the driver 14A is configured to generate the first bias control signal V1 based on MSBs from the data source 12, and the driver 14B is configured to generate the second bias control signal V2 based on LSBs from the data source 12. The drivers 14A and 14B, even considered together, represent a simplified version of the driver 14 in the modulation system 10 shown in FIG. 1. Each of the drivers 14A and 14B can be embodied as a relatively simple transistor-based amplifier as compared to the driver 14 shown in FIG. 1.

The bias control signal V1 can be embodied as a type of differential output from the driver 14A, but the driver 14A can also output a single-ended bias control signal in some cases. The bias control signal V2 can be embodied as a type of differential output from the driver 14B, but the driver 14B can also output a single-ended bias control signal in some cases. The bias control signals V1 and V2 are examples of bias voltage (e.g., electric potential) control signals. The drivers 14A and 14B can also generate bias current control signals or combinations of bias voltage and bias current control signals in various embodiments.

The first driver 14A is designed for operation at an amplification or gain level of “X,” and the second driver 14B is designed for operation at an amplification or gain level of “AX,” where “A” is either unity (i.e., 1) or a fraction of unity (i.e., less than 1), such as ⅓. In other words, the gain of the second driver 14B is a fraction of the gain of the first driver 14A. In that implementation, the driver 14B is designed to output a bias control signal having ⅓ the magnitude of the driver 14A, for the same amplitude electrical input signal. Stated differently, the driver 14B outputs a bias control signal having ⅓ the magnitude of the driver 14A, for the same true or “1” MSB/LSB logic level applied to the drivers 14A and 14B. The sizes of the transistors or amplifiers in the drivers 14A and 14B can be different than each other to achieve the respective gain factors of “X” and “AX.” Other gain ratios of X:AX, besides 1:⅓, can be relied upon, such as 1:1, 1:½, 1:¼, and other ratios. In other examples, the driver 14A can be designed for operation at an amplification or gain level of “AX,” and the driver 14B can be designed for operation at an amplification or gain level of “X”.

As compared to the driver 14 in the modulation system 10 in FIG. 1, the drivers 14A and 14B can be relatively smaller, less complicated (e.g., omit distortion compensation, linearization, or other circuit aspects required of PAM-4 electrical amplifiers, etc.), more efficient, and less costly to implement, because they only need to generate two output levels, instead of resolving four levels.

In some implementations, one or both of the drivers 14A and 14B can incorporate circuitry for varied frequency-domain performance, such as frequency-domain “uptilt,” higher-frequency peaking gain, or related adjustments that compensate for frequency-related performance variations of the modulator arms 33 and 35 and the phase shifters 34 and 36. The drivers 14A and 14B can include equalization circuitry for gain shaping functions, phase shaping or distortion functions, and other functions based on the operating frequency and baud rate of the modulation system 10A, as directed by the controller 16. In some cases, the drivers 14A and 14B can incorporate equalization networks, continuous-time linear equalizers (CTLEs), frequency-dependent feedback paths, or other circuitry to pre-emphasize spectral components of the first and second bias control signals V1 and V2. Thus, the drivers 14A and 14B can incorporate circuitry to maintain and restore frequency flatness, improve eye openings, reduce inter-symbol interference (ISI), and enable higher symbol rates.

The controller 16 can be configured to control the operations of the modulation system 10A, in connection with the data source 12 and the drivers 14A and 14B, to modulate the carrier wave provided from the generator 20. The controller 16 is thus communicatively coupled to (e.g., via a local interface or bus) and configured to control, monitor, and direct the operations of the data source 12, the drivers 14A and 14B, the generator 20, and the modulator 30. The controller 16 can also be communicatively coupled to an external system computer or controller for status reporting, error reporting, and the communication of other data and control signals. The gain, equalization, and other parameters of the modulation system 10A can thus be monitored and optimized based on external system control in some cases.

The controller 16 can be embodied as circuits or circuitry including general purpose or application specific integrated circuit (ASIC) processors, with memory. The controller 16 can include circuitry for data conditioning, clock generation, and bias driving (e.g., current and/or voltage) control. For clock generation and other control purposes, the controller 16 can include one or more internal registers and related circuitry that is electrically coupled to the data source 12, the drivers 14A and 14B, the generator 20, and possibly other components of the modulation system 10A through one or more local interfaces. For data conditioning and related purposes, the controller 16 can include adaptive or programmable buffers, filters, equalizers, etc.

The generator 20 is configured to generate an electromagnetic wave, as a type of carrier wave, for modulation with data by the modulator 30. The generator 20 can generate an electromagnetic wave in the RF, microwave, infrared, or visible spectrums. As one example, the generator 20 can be embodied as a light or laser light generator, such as a semiconductor laser, configured to generate coherent light at a particular wavelength through stimulated emission. As another example, the generator 20 can be embodied as an RF generator configured to generate an RF signal at a consistent frequency and phase.

The generator 20 is capable of generating a coherent carrier wave in preferred embodiments. The generator 20 can be configured to generate a carrier wave at a continuous level of power and at a substantially fixed frequency or wavelength and phase over time, although the generator 20 can also generate a carrier wave having a varying level of power, frequency or wavelength, and phase over time in some implementations. The generator 20 can be biased and controlled for operation by a power source, the controller 16, and related power and control circuitry. The carrier wave generated by the generator 20 is provided as an input to the modulator 30.

The bias control signals V1 and V2 are provided to the phase shifters 34 and 36 of the modulator 30, separately. The modulator 30 is configured to modulate the carrier wave provided from the generator 20, over time, through interferometry based on the bias control signals V1 and V2 generated by the drivers 14A and 14B. The modulator 30 imparts phase shifts in the modulator arms 33 and 35 using the phase shifters 34 and 36 based on the control signals V1 and V2, respectively, to modulate the carrier wave provided from the generator 20. Phase differences introduced in the modulator arms 33 and 35 by the phase shifters 34 and 36 result in constructive or destructive interference in the output of the combiner 38, resulting in modulation of the carrier wave input to the modulator 30. Thus, the modulator 30 generates a modulated carrier wave output and provides the modulated carrier wave output to the communications medium 40, which can be an antenna, a waveguide, free space, a copper cable, a fiber optic cable, or another cable or medium.

In effect, the phase shifters 34 and 36 are configured to impart path length changes on the modulator arms 33 and 35, respectively, based on the bias control signals V1 and V2. In some cases, both the phase shifters 34 and 36 are designed to impart the same type of path lengthening or shortening effect on the modulator arms 33 and 35 for the same bias control signal applied. In other cases, one of the phase shifters 34 and 36 is designed to impart a path lengthening effect and another one of the phase shifters 34 and 36 is designed to impart a path shortening effect on the modulator arms 33 and 35 for the same bias control signal applied. PAM encoding can be achieved in different ways depending on how the phase shifters 34 and 36 effectively lengthen or shorten the modulator arms 33 and 35, as described in further detail below.

Phase differences introduced in the modulator arms 33 and 35 by the phase shifters 34 and 36 result in constructive or destructive interference in the output of the combiner 38, resulting in modulation of the wave input to the modulator 30. Thus, the modulator 30 generates a modulated wave output and provides the modulated wave output to the communications medium 40. The modulation system 10A can generate PAM-4 symbols using the modulator 30, based on the bias control signals V1 and V2 generated by the drivers 14A and 14B and the data from the data source 12.

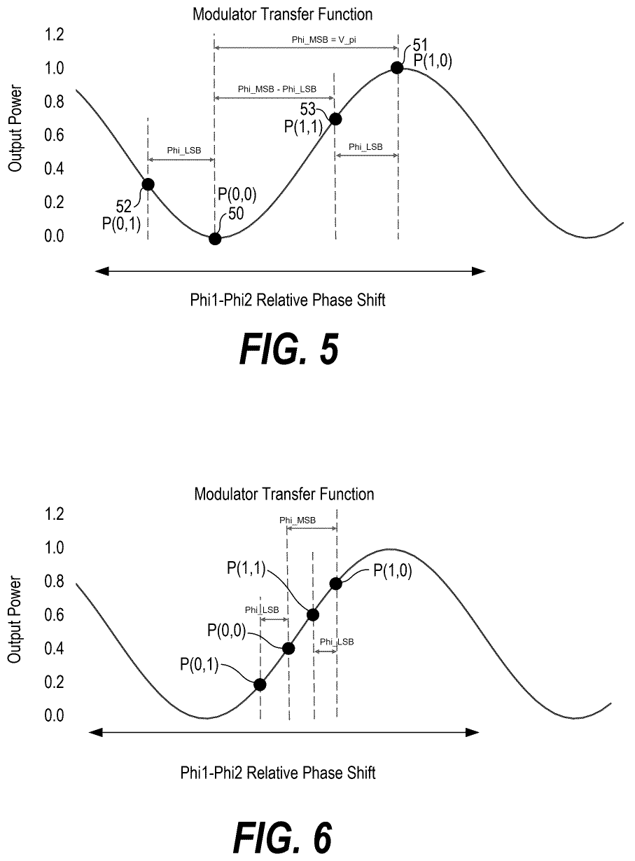

As described in further detail below, the drivers 14A and 14B and phase shifters 34 and 36 can be designed to obtain one or more of the transfer functions shown in FIGS. 5, 6, and 8, among possibly others. The transfer functions are achieved by different types of phase shifts, effective path lengthening, or effective path shortening on the modulator arms 33 and 35, respectively. To implement the different transfer functions, the phase shifters 34 and 36 can be designed to have either the same or different “polarities” as compared to each other. In other words, for the same bias control signal V1, V2, the phase shifters 34 and 36 can be designed to both provide the same phase shift (e.g., both effectively lengthen or shorten the paths of the modulator arms 33 and 35 by the same amount), to provide different phase shifts in the same direction (e.g., both effectively lengthen or shorten the paths of the modulator arms 33 and 35 by different amounts), to provide the same but opposite phase shifts as compared to each other, or to provide different and opposite phase shifts as compared to each other. These and other aspects of the embodiments are described below.

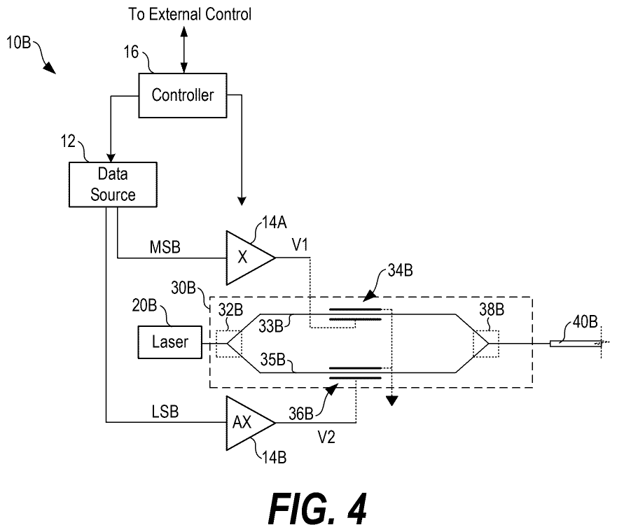

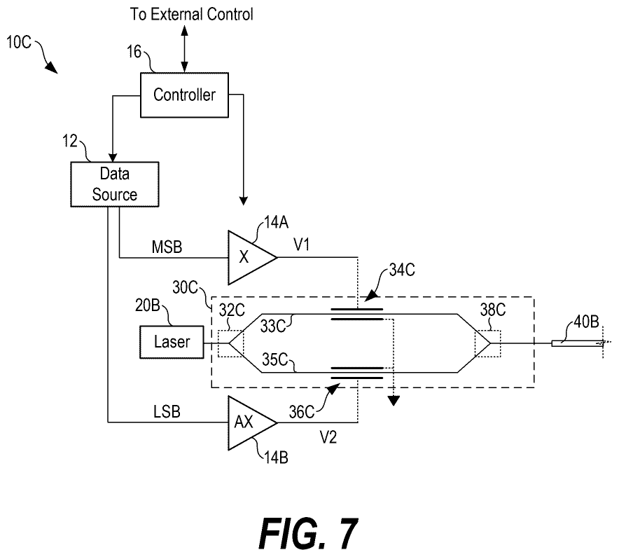

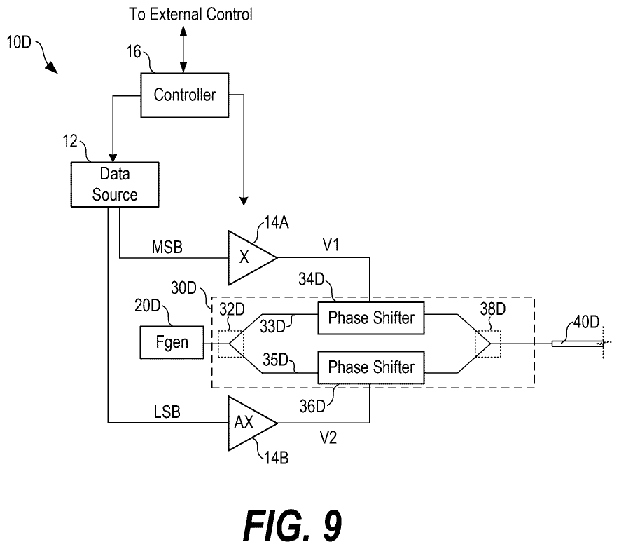

The modulation system 10A shown in FIG. 3 can be implemented in different ways to facilitate the modulation of signals or carrier waves in the RF, microwave, infrared, visible light, and other spectrums. Example optical modulation systems are described in connection with FIGS. 4 and 7, and an example RF modulation system is described in connection with FIG. 9. The concepts described herein can also be extended to other modulators for microwave, infrared, and other signals.

FIG. 4 illustrates an example optical modulation system 10B according to various embodiments described herein. The optical modulation system 10B is a representative example of an interferometric optical modulation system according to the embodiments described herein. The optical modulation system 10B can include one or more additional components that are not shown in FIG. 4 in some cases. The optical modulation system 10B can also omit one or more of the components shown in FIG. 4 in other cases, and variations on the structure of the optical modulation system 10B are within the scope of the embodiments.

The optical modulation system 10B includes the data source 12, the driver 14A, the driver 14B, the controller 16, a laser light generator 20B (also “laser 20B”), an optical modulator 30B, and an optical communications medium 40B, among possibly other components. The optical modulator 30B includes an optical splitter 32B, a first modulator arm 33B with phase shifter 34B, a second modulator arm 35B with phase shifter 36B, and an optical combiner 38B, among possibly other components.

The components depicted in FIG. 4 can be implemented together on a common semiconductor or other integrated optical substrate in a single package in some cases, but certain components can also be implemented separately from and interfaced with each other. As one example, the data source 12, drivers 14A and 14B, and controller 16 can be implemented as a single integrated device, as a combination of discrete components, or a combination of integrated and discrete components and circuitry. The optical modulator 30B can be implemented as a separate photonic integrated circuit (PIC) or integrated optical circuit, and the data source 12, drivers 14A and 14B, and controller 16 can be interfaced with the optical modulator 30B. Other implementations are also within the scope of the embodiments.

The data source 12 in FIG. 4 can be the same as or similar to the data source 12 shown in FIG. 3. The drivers 14A and 14B in FIG. 4 can also be the same as or similar to the drivers 14A and 14B shown in FIG. 3. In the optical modulation system 10B, two-level MSB and LSB electrical data is provided to the drivers 14A and 14B, separately, for each PAM-4 symbol from the data source 12. Thus, the driver 14A is configured to generate the first bias control signal V1 based on MSBs from the data source 12, and the driver 14B is configured to generate the second bias control signal V2 based on LSBs from the data source 12.

The controller 16 can be configured to control the operations of the optical modulation system 10B, in connection with the data source 12 and the drivers 14A and 14B, to modulate the output provided from the laser 20B. The controller 16 is thus configured to control, monitor, and direct the operations of the data source 12, the drivers 14A and 14B, and the optical modulator 30B. The controller 16 can also be communicatively coupled to an external system computer or controller for status reporting, error reporting, and the communication of other data and control signals. The gain, equalization, and other parameters of the optical modulation system 10B can thus be monitored and optimized based on external system control in some cases.

The laser 20B can be embodied as a light or laser light generator, such as a semiconductor laser, configured to generate coherent light at a particular wavelength through stimulated emission. The laser 20B can be embodied as a double heterostructure laser, a distributed Bragg reflector laser (DBR), a distributed-feedback laser (DFB), a vertical-cavity surface-emitting laser (VCSEL), or related type of laser. The laser 20B can be configured to generate light at a continuous (e.g., static over time) level of power and at a substantially fixed wavelength and phase over time, although the laser 20B can also be configured to generate light at varying levels of power, wavelength, and phase in some cases.

The optical modulator 30B includes the optical splitter 32B, first modulator arm 33B with phase shifter 34B, second modulator arm 35B with phase shifter 36B, and the optical combiner 38B, among possibly other components. The optical modulator 30B can be implemented as a type of Mach Zender (MZ) modulator, as shown. The first and second modulator arms 33B and 35B can be embodied in materials such as lithium niobate (LiNbO₃), gallium arsenide (GaAs), indium phosphide (InP), barium-titanate, electro-optic polymer or other materials capable of altering refractive indexes based on changing electric fields. The phase shifters 34B and 36B can be embodied as electrodes positioned on, along, and/or across the modulator arms 33B and 35B to impart the phase shifts based on the bias control signals V1 and V2. The light that travels through the modulator arms 33B and 35B is recombined by the optical combiner 38B. Due to the phase differences introduced in the modulator arms 33B and 35B by the phase shifters 34B and 36B, constructive or destructive interference occurs in the output of the optical combiner 38B, resulting in intensity modulation of the light output from the optical modulator 30B.

The optical modulator 30B can also include additional components that are not illustrated in FIG. 4. For example, the optical modulator 30B can include an optical power tap and photodiode at the output of the optical modulator 30B or at other suitable locations within the optical modulator 30B. The photodiode can monitor the bias point (e.g. direct current (DC) bias) of the laser 20B, the optical modulator 30B, or both and send a related control signal back to the controller 16 as feedback for bias control. The optical modulator 30B can also include DC bias electrodes driven by the controller 16, using the electro-refraction effect, the thermo-optic effect, or other approach to set and maintain the DC bias point of the optical modulator 30B.

In the optical modulator 30B, the power of the light provided from the laser 20B is split by the optical splitter 32B and directed into the first modulator arm 33B and the second modulator arm 35B. The light in the first modulator arm 33B is subjected to a phase shift by the phase shifter 34B based on the first bias control signal V1, and light in the second modulator arm 35B is subjected to a phase shift by the phase shifter 36B based on the second bias control signal V2. The phase shifters 34B and 36B impart phase shifts or, in effect, different path lengths on the light that travel through the modulator arms 33B and 35B, respectively, based on the bias control signals V1 and V2. Phase differences introduced in the modulator arms 33B and 35B by the phase shifters 34B and 36B result in constructive or destructive interference in the output of the combiner optical 38B, resulting in modulation of the light input to the optical modulator 30B. Thus, the optical modulator 30B generates a modulated light output and provides the modulated light output to the communications medium 40, which can be free space, a fiber optic cable, or another medium.

The first driver 14A is designed for operation at an amplification or gain level of “X,” and the second driver 14B is designed for operation at an amplification or gain level of “AX,” where “A” is a fraction (i.e., less than 1), such as ⅓. In that implementation, the driver 14B is designed to output a bias control signal having ⅓ the magnitude of the driver 14A, for the same amplitude electrical input signal. Stated differently, the driver 14B outputs a bias control signal having ⅓ the magnitude of the driver 14A, for the same MSB/LSB logic level applied to the drivers 14A and 14B. The sizes of the transistors or amplifiers in the drivers 14A and 14B can be different than each other to achieve the respective gain factors of “X” and “AX.”

The bias control signals V1 and V2 are provided to the phase shifters 34B and 36B of the optical modulator 30B separately. In the example shown in FIG. 4, the bias control signals V1 and V2 are provided to the phase shifters 34B and 36B such that the electric fields induced by the signals V1 and V2 are co-linear and in the same direction across each of the modulator arms 33B and 35B. This has the effect of the subtraction of the phase of light through the modulator arm 35B from the phase of light through the modulator arm 35B, Phi_MSB−Phi_LSB, in the optical combiner 38B, when the light in the modulator arms 33B and 35B interfere with each other in the optical combiner 38B. The output of the optical modulator 30B is provided to the optical communications medium 40B, which can be free space, a fiber optic cable, or another medium.

The optical modulation system 10B is designed and configured to maintain in-time phase between the V1 and V2 output signals of the drivers 14A and 14B and the original timings (e.g., edges) of the MSB and LSB bit-pairs from the data source 12. The time delay from the data source 12, through the driver 14A, and to and through the phase shifter 34B is designed to be the same as the time delay from the data source 12, through the driver 14B, and to and through the phase shifter 36B. The controller 16, drivers 14A and 14B, and optical modulator 30B can be configured to equalize the timings of the V1 and V2 output signals, so that MSB and LSB signals are applied to the first and second modulator arms 33B and 35B at the same time. The drivers 14A and 14B and the controller 16 may incorporate circuitry to manage the timing of the MSB and LSB input signals, the V1 and V2 output signals, or both.

FIG. 5 illustrates an example transfer function of output power (e.g., PAM amplitude) versus relative phase shift for the optical modulation system 10B shown in FIG. 4. The four points 50-53 on the transfer function in FIG. 5 correspond to the four PAM-4 optical output intensity levels of P(0,0)=0, P(0,1)=P/3, P(1,1)=2P/3, and P(1,0)=P generated at the output of the optical modulator 30B based on the MSB bias control signal V1 and the LSB bias control signal V2.

When the LSB is zero, and the MSB is also zero, the P(0,0) condition corresponds to the output of the minimum transmission point 50 from the optical modulator 30B. When the LSB is zero and the MSB is one, the P (1,0) condition corresponds to the output of the maximum transmission point 51 from the optical modulator 30B. When the LSB is applied, this has the effect of subtracting ⅓ of the MSB phase at the output of the optical modulator 30B, such that the P(0,1) point 52 and the P (1,1) point 53 can also be generated. The transfer function shown in FIG. 5 is generated when the electrodes of the phase shifters 34B and 36B are configured to have the same polarity across the modulator arms 33B and 35B, such that a relative phase of −⅓ is applied when the LSB is 1. The function P(MSB,LSB) shown in FIG. 5 defines the four levels of the PAM-4 gray-code optical signal in Table 1.

The driver 14A can be designed to have a gain of G_MSB, such that the application of the MSB “1” signal causes the bias control signal V1 to switch between an electrical potential of zero (or near zero) and an electric potential of G_MSB*V_MSB=V_pi, where V_pi is the full on-off switching voltage of the optical modulator 30B. That is, when the LSB is held at “0,” the optical modulator 30B switches from zero optical output to full optical output based on only the transition of the MSB from data “0” to “1” and the corresponding transition of the bias control signal V1 from an electrical potential of zero to an electric potential of V_pi.

The driver 14B can be designed to have a gain of G_LSB, such that the application of the LSB “1” signal causes the bias control signal V2 to switch between an electrical potential of zero (or near zero) and an electric potential of G_LSB. The gain of G_LSB is lower than G_MSB. G_LSB can be approximately ⅓ of G_MSB in one example, although G_LSB can be a different factor of G_MSB in other cases. The optical modulator 30B shown in FIG. 4 is designed to impart the subtraction of the LSB phase from the MSB phase such that, upon interference, the raised-cosine transfer function shown in FIG. 5 produces the 4-level PAM-4 optical output.

The drivers 14A and 14B only need to generate two electrical output levels. Thus, the drivers 14A and 14B can be simple and limiting-type amplifiers and do not need to be highly linear, as required if the input signal to the driver amplifiers was a 4-level PAM-4 electrical signal waveform. This simplifies the design of the drivers 14A and 14B as compared to the driver 14 shown in FIG. 1 and potentially reduces power, semiconductor chip size, and overall cost.

The optical modulator 30B can also be DC-biased to the point corresponding to P(0,0) point 50 in some cases and/or to the extent needed. The optical modulator 30B can be DC-biased for the P(0,0) point 50 by the drivers 14A and 14B in one example. In that case, the bias control signals V1 and V2 can be non-zero (i.e., potentials or currents other than zero) for MSB and LSB data values of “0”. In other cases, the optical modulator 30B can include other electrodes and driver circuitry to set the P(0,0) point 50 to an output power of zero (or near zero) for MSB and LSB data values of “0”.

Other transfer characteristics can be implemented using the optical modulation system 10B and are within the scope of the embodiments. Other transfer functions or characteristics can be implemented by varying the gains of one or both of the drivers 14A and 14B, changing the polarity of the electric fields induced by the bias control signals V1 and V2 across the modulator arms 33B and 35B using the phase shifters 34B and 36B, or combinations thereof.

FIG. 6 illustrates another example transfer function of output power versus relative phase shift for the modulation systems 10B shown in FIG. 4. The transfer function shown in FIG. 6 is a more generalized case and can be achieved by changing the gains of one or both of the drivers 14A and 14B, changing the biasing of the optical modulator 30B for the point P(0,0), or changing both. In some cases, the nominal outputs, bias voltage output, or bias current output of one or both of the drivers 14A and 14B can also be altered as compared to that discussed above.

In this case, G_MSB produces a maximum signal amplitude less than V_pi in the example shown in FIG. 5, and G_LSB is approximately scaled by ⅓ of the maximum MSB value. The optical modulator 30B can be DC-biased at the point corresponding to P(0,0) as needed. This produces relative optical outputs of P(0,1)=d (i.e., the lowest output power), P(0,0)=d+⅓, P(1,1)=d+⅔, and P(1,0)=d+1, as shown in FIG. 6. Overall, a phase shift for a logic true of the MSB in the first modulator arm is greater than a phase shift for a logic true of the less significant bit in the second modulator arm. The transfer function shown in FIG. 6 provides a type of non-standard PAM-4 output, as shown below in Table 2.

TABLE 2
Generalized, Non-Standard 4-Level PAM-4 Output

| MSB | LSB | PAM-4 Relative Output |
|---|---|---|
| 1 | 0 | d + 1 |
| 1 | 1 | d + 2/3 |
| 0 | 0 | d + 1/3 |
| 0 | 1 | d |

FIG. 7 illustrates another example optical modulation system 10C. The optical modulation system 10C includes the data source 12, the driver 14A, the driver 14B, the controller 16, the laser 20B, an optical modulator 30C, and an optical communications medium 40B, among possibly other components. The optical modulator 30C includes an optical splitter 32C, a first modulator arm 33C with phase shifter 34C, a second modulator arm 35C with phase shifter 36C, and an optical combiner 38C, among possibly other components.

The optical modulation system 10C in FIG. 7 is similar to the optical modulation system 10B shown in FIG. 4. However, the phase shifter 34C is configured to apply the bias control signal V1 across the first modulator arm 33C in a different, and opposite, direction as compared to the application of the bias control signal V2 across the second modulator arm 35C by the phase shifter 36C. The biasing and electrode arrangement shown in FIG. 7 has the effect of causing the voltage-induced optical phases among the modulator arms 33C and 35C to add rather than subtract when the optical signals interfere in the optical combiner 38C.

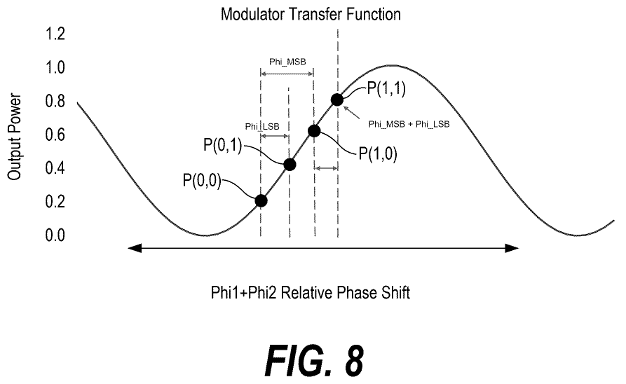

FIG. 8 illustrates an example transfer function of output power versus relative phase shift for the optical modulation system 10C shown in FIG. 7. In this case, G_MSB again produces a maximum signal amplitude less than V_pi in the example shown in FIG. 5, and G_LSB is approximately scaled by ⅓ of the maximum MSB value. The optical modulator 30D can be DC-biased at the point corresponding to P(0,0) as needed. This produces relative optical outputs of P(0,0)=d, P(0,1)=d+⅓, P(1,0)=d+⅔, and P(1,1)=d+1, as shown in FIG. 8. The level “d” is again considered to be the lowest or “zero” level of the PAM-4 output optical signal. The transfer function shown in FIG. 8 provides a type of non-gray-code, non-standard PAM4 output, as shown below in Table 3.

TABLE 3
Alternative Configuration for Non-
Standard 4-Level PAM-4 Output

| MSB | LSB | PAM-4 Relative Output |
|---|---|---|
| 1 | 1 | d + 1 |
| 1 | 0 | d + 2/3 |
| 0 | 1 | d + 1/3 |
| 0 | 0 | d |

Other embodiments are directed to RF modulators capable of data communications using carrier waves in the gigahertz (GHz) and even into the terahertz (THz) range. For example, FIG. 9 illustrates an RF modulation system 10D according to various embodiments described herein. The RF modulation system 10D is a representative example of an interferometric RF modulator or modulation system capable of PAM-4 modulation according to the embodiments described herein. In some cases, the RF modulation system 10D can include additional components that are not shown in FIG. 9. The RF modulation system 10D can also omit one or more of the components shown in FIG. 9 in other cases.

As shown in FIG. 9, the RF modulation system 10D includes the data source 12, the driver 14A, the driver 14B, the controller 16, a frequency generator 20D, an RF modulator 30D, and the communications medium 40D, among possibly other components. The RF modulator 30D includes an RF splitter 32D, a first modulator arm 33D with phase shifter 34D, a second modulator arm 35D with phase shifter 36D, and an RF combiner 38D, among possibly other components. The components and operation of the RF modulation system 10D are described in further detail below.

The components depicted in FIG. 9 can be implemented together on a common semiconductor substrate in a single package in some cases, but certain components can also be implemented separately from and interfaced with each other. As one example, the data source 12, drivers 14A and 14B, and controller 16 can be implemented together as single integrated circuit on a common semiconductor substrate. The frequency generator 20D and the RF modulator 30D can be implemented as another integrated circuit, such as a monolithic microwave integrated circuit (MMIC), and the data source 12, drivers 14A and 14B, and controller 16 can be interfaced with the frequency generator 20D and the RF modulator 30D.

The frequency generator 20D can be configured to generate an RF carrier wave at a continuous (e.g., static over time) level of power and at a substantially fixed frequency and phase over time, although the frequency generator 20D can also generate a carrier wave at a varying level of power, frequency, and phase over time in some implementations. The frequency generator 20D can be embodied in part as an oscillator circuit, such as an LC tank circuit, dielectric resonator, crystal oscillator, or other resonant circuitry configured to establish a fundamental frequency. To achieve output frequency variability or tunability, the frequency generator 20D can incorporate a voltage-controlled oscillator (VCO) or related circuitry for variable frequency control. In that case, the frequency generator 20D can vary the frequency of the carrier signal by adjusting a control voltage provided to a varactor diode, for example, which can be relied upon to alter the frequency of the carrier signal. In some cases, the frequency generator 20D can incorporate a phase-locked loop (PLL), frequency divider, frequency multiplier, frequency mixer, or other circuit elements. The operation of the frequency generator 20D can be controlled by the controller 16 in some cases, as needed.

The frequency generator 20D can generate a carrier signal having a relatively high frequency, including frequencies in the gigahertz (GHz) and even into the terahertz (THz) range. The frequency generator 20D can generate a carrier signal in the range of 50-1,000 GHz, for example, and other frequencies can be relied upon. As more particular examples, the frequency generator 20D can generate a carrier signal in a range between about 110-220 GHz, including any frequency between about 110 GHz and about 220 GHz, and other frequencies can be relied upon.

The RF modulator 30D includes an RF splitter 32D, a first modulator arm 33D with phase shifter 34D, a second modulator arm 35D with phase shifter 36D, and an RF combiner 38D, among possibly other components. The RF modulator 30D receives a carrier signal from the frequency generator 20D as an input, and the RF modulator 30D generates a modulated output signal as an output to the communications medium 40D. The RF modulator 30D is designed to operate as a type of interferometric modulator. The RF modulator 30D is configured to modulate the carrier signal received from the frequency generator 20D based on the bias control signals V1 and V2. More particularly, the RF modulator 30D is configured to split the carrier signal onto two separate paths, shift the phases of the signals on the two paths based on the bias control signals V1 and V2 using the phase shifters 34D and 36D, and recombine the paths of the carrier signal to arrive at an interferometrically modulated carrier signal output.

The output of the RF modulator 30D, which is single-ended, is provided to the communications medium 40D, which can be embodied as a dielectric waveguide, the atmosphere, free space, or another suitable medium. The output of the RF modulator 30D can also be amplified in some cases, if needed, before it is provided to the communications medium 40D for transmission to a receiver and demodulator.

The RF splitter 32D is configured to split and direct the power of the carrier signal received from the frequency generator 20D into the first modulator arm 33D and the second modulator arm 35D. As examples, the RF splitter 32D can be embodied as a resistive divider, a Wilkinson power divider, or other circuitry designed to split the power of an RF signal into two or more paths. The RF splitter 32D can be designed to impart little or no phase shift upon the signals directed onto the modulator arms 33D and 35D, as compared to the carrier signal received from the frequency generator 20D. Thus, the RF splitter 32D can be embodied as a resistive divider, a Wilkinson power divider, or other circuitry designed to split the power of the carrier signal without imparting phase shifts. In other implementations, the RF splitter 32D can be embodied as a type of power splitter that imparts a phase shift upon one or both of the signals directed onto the modulator arms 33D and 35D, such as a 90° or 180° hybrid coupler, in which case the phase shifters 34D and 36D can be altered in design to account for the shift imparted by the RF splitter 32D.

The first and second modulator arms 33D and 35D can be embodied as a pair of parallel-extending microstrip transmission lines, for example, or other transmission paths for the split output from the RF splitter 32D. The first and second modulator arms 33D and 35D can have the same electrical path length as compared to each other, in at least some configurations, and the phase shifters 34D and 36D are designed to impart phase shifts or, in effect, different path lengths upon the modulator arms 33D and 35D.

The phase shifters 34D and 36D impart phase shifts or, in effect, different path lengths on the signals that travel through the modulator arms 33D and 35D, respectively, based on the bias control signals V1 and V2. The modulator arms 33D and 35D can be embodied, at least in part, by transmission lines, and the phase shifters 34D and 36D are placed or implemented along at least a length of the transmission lines in at least one example. The phase shifters 34D and 36D are configured to alter or change the actual or effective electrical path length of the modulator arms 33D and 35D, as measured between the RF splitter 32D and the RF combiner 38D, based on the bias control signals V1 and V2.

The phase shifters 34D and 36D can be implemented in a variety of ways, such as one or more varactor diodes, PIN diodes, or other switching devices having variable or selectable capacitances which alter the effective permittivity of the modulator arms 33D and 35D, using switchable line segments or stubs of known lengths to change the electrical path length of the modulator arms 33D and 35D, using ferrite, dielectric, or semiconductor technologies, or related approaches. In one example, the phase shifter 34D can include at least one first switching device having a variable capacitance electrically coupled along the modulator arm 33D, and the phase shifter 36D can include at least one switching device having a variable capacitance electrically coupled along the modulator arms 35D.

In one example, the phase shifters 34D and 36D can be implemented using one or more varactor diodes (e.g., voltage-controlled capacitors) electrically coupled between the modulator arms 33D and 35D, separately, and signal ground at regular intervals. The capacitances of the varactor diodes can be varied based on the bias control signals V1 and V2, which results in a change to the effective propagation constant along the modulator arms 33D and 35D. In another example, the phase shifters 34D and 36D can be implemented using one or more switched LC ladder networks, or other switchable impedances.

The carrier signals that travel through the modulator arms 33D and 35D, which can be shifted in phase as compared to each other by the phase shifters 34D and 36D, are recombined by the RF combiner 38D. Due to the phase differences introduced in the modulator arms 33D and 35D by the phase shifters 34D and 36D, constructive or destructive interference occurs in the output of the RF combiner 38D, resulting in amplitude modulation of the carrier signal. The output of the RF modulator 30D can be referred to as a modulated carrier signal or a modulated signal.

As noted above, the RF modulator 30D can modulate the carrier signal generated by the frequency generator 20D to carry PAM-4 symbols based on the bias control signals V1 and V2 generated by the drivers 14A and 14B and the data from the data source 12. According to aspects of the embodiments, PAM-4 signals are generated by organizing the data in the data source 12 into pairs of data bits, with each pair of data bits including an MSB and an LSB.

In the RF modulation system 10D, two-level MSB and LSB electrical data is provided to the drivers 14A and 14B, separately, for each PAM-4 symbol from the data source 12. Thus, the driver 14A is configured to generate the first bias control signal V1 based on MSBs from the data source 12, and the driver 14B is configured to generate the second bias control signal V2 based on LSBs from the data source 12. The drivers 14A and 14B, even considered together, represent a simplified version of the driver 14 in the modulation system 10 shown in FIG. 1. Each of the drivers 14A and 14B can be embodied as a relatively simple transistor-based amplifier as compared to the driver 14 shown in FIG. 1.

The RF modulation system 10D is designed and configured to maintain in-time phase between the V1 and V2 outputs of the drivers 14A and 14B and the original timings (e.g., edges) of the MSB and LSB bit-pairs from the data source 12. That is, the time delay from the data source 12, through the driver 14A, and to and through the phase shifter 34D, is designed to be the same as the time delay from the data source 12, through the driver 14B, and to and through the phase shifter 36D.

The drivers 14A and 14B are designed to generate the bias control signals V1 and V2, respectively, based on the MSB and LSB data from the data source 12. Thus, in at least one example, the drivers 14A and 14B are configured to amplify the logic conditions of the MSB and LSB data signals, directly, and provide amplified logic conditions as the bias control signals V1 and V2 to the phase shifters 34D and 36D. The bias control signals V1 and V2 from the drivers 14A and 14B can be used to control the variable capacitances of varactor diodes, PIN diodes, or other circuitry in the phase shifters 34 and 36, respectively, as described herein.

The drivers 14A and 14B and phase shifters 34 and 36 can be designed to obtain one or more of the transfer functions shown in FIGS. 5, 6, and 8, among possibly others. The transfer functions are achieved by different types of phase shifts, effective path lengthening, or effective path shortening on the modulator arms 33D and 35D, respectively. To implement the different transfer functions, the phase shifters 34D and 36D can be designed to have either the same or different polarities as compared to each other. In other words, for the same bias control signal V1, V2, the phase shifters 34D and 36D can be designed to both provide the same phase shift (e.g., both effectively lengthen or shorten the paths of the modulator arms 33D and 35D by the same amount), to provide different phase shifts in the same direction (e.g., both effectively lengthen or shorten the paths of the modulator arms 33D and 35D by different amounts), to provide the same but opposite phase shifts as compared to each other, or to provide different and opposite phase shifts as compared to each other.

Additionally, depending on the designs of the phase shifters 34D and 36D, the drivers 14A and 14B can have the same gain as each other or different gains as compared to each other. The driver 14A can be designed for operation at an amplification or gain level of “X,” and the driver 14B can be designed for operation at an amplification or gain level of “AX,” where “A” is either unity (i.e., 1) or a fraction of unity (i.e., less than 1), such as ⅓. Thus, the driver 14B can be designed to output a bias control signal having ⅓ the magnitude of the driver 14A, for the same logic or amplitude of input signal. Other gain ratios of X:AX, besides 1:⅓, can be relied upon, such as 1:1, 1:½, 1:¼, and other ratios. In other examples, the driver 14A can be designed for operation at an amplification or gain level of “AX,” and the driver 14B can be designed for operation at an amplification or gain level of “X”. Thus, the transistor or power amplifier sizes of the drivers 14A and 14B can be different than each other in some cases.

The bias control signals V1 and V2 are provided to the phase shifters 34D and 36D separately. If the phase shifters 34D and 36D impart the same type or polarity of phase shift (e.g., in the same direction) in each of the modulator arms 33D and 35D for the same bias control signals V1 and V2, then the interference in the RF combiner 38D can have the effect of subtracting the phase through the modulator arm 35D from the phase through the modulator arm 35D (e.g., Phi_MSB−Phi_LSB) at the output of the RF modulator 30D.

FIG. 5 illustrates an example transfer function of output power (e.g., PAM amplitude) versus relative phase shift for the RF modulation system 10D shown in FIG. 9 when the phase shifters 34D and 36D impart the same type or polarity of phase shift. The four points 50-53 on the transfer function in FIG. 5 correspond to the four PAM-4 output levels, P(0,0)=0, P(0,1)=P/3, P(1,1)=2P/3, and P(1,0)=P, that can be generated at the output of the RF modulator 30D based on the MSB bias control signal V1 and the LSB bias control signal V2.

The driver 14A can be designed to have a gain of G_MSB, such that the application of the MSB “1” signal causes the bias control signal V1 to switch between an electrical potential of zero (or near zero) and an electric potential of G_MSB*V_MSB=V_pi, where V_pi is the full on-off switching voltage of the RF modulator 30D. That is, when the LSB is held at “0,” the RF modulator 30D switches from zero output to full output amplitude based on only the transition of the MSB from data “0” to “1” and the corresponding transition of the bias control signal V1 from an electrical potential of zero to an electric potential of V_pi.

The driver 14B can be designed to have a gain of G_LSB, such that the application of the LSB “1” signal causes the bias control signal V2 to switch between an electrical potential of zero (or near zero) and an electric potential of G_LSB. The gain of G_LSB is lower than G_MSB. G_LSB can be approximately ⅓ of G_MSB in one example, although G_LSB can be different factors of G_MSB in other cases. The RF modulation system 10D shown in FIG. 9 is designed to impart the subtraction of the LSB phase from the MSB phase such that, upon interference, the raised-cosine transfer function shown in FIG. 5 produces the 4-level PAM-4 output in the detected power.

The RF modulator 30D can also be DC-biased to the point corresponding to P(0,0) point 50, in some cases and/or to the extent needed. The RF modulator 30D can be DC-biased for the P(0,0) point 50 by the drivers 14A and 14B in one example. In that case, the bias control signals V1 and V2 can be non-zero (i.e., potentials or currents other than zero) for MSB and LSB data values of “0”. In other cases, the RF modulation system 10D can include other electrodes and driver circuitry to set the P(0,0) point 50 to an output power of zero (or near zero) for MSB and LSB data values of “0” (not shown for clarity).

Other transfer characteristics can be implemented using the RF modulation system 10D and are within the scope of the embodiments. Other transfer characteristics can be implemented by varying the gains of one or both of the drivers 14A and 14B, changing the designs (e.g., the phase shifts or polarities) of the phase shifters 34D and 36D, or combinations thereof. In particular, the amplitudes of the drivers 14A and 14B can be adjusted to generate a PAM-4 modulation of the RF carrier amplitude instead of the RF carrier power. This may be advantageous in some implementations. Detection of the RF amplitude or power may be employed, including the use of coherent or superheterodyne detection schemes, among others.

FIG. 6 illustrates another example transfer function of output power versus relative phase shift for the RF modulation system 10D shown in FIG. 9. The transfer function shown in FIG. 6 is a more generalized case and can be achieved by changing the gains of one or both of the drivers 14A and 14B, changing the biasing of the RF modulator 30D for the point P(0,0), or changing both. In some cases, the nominal outputs, bias voltage output, or bias current output of one or both of the drivers 14A and 14B can also be altered as compared to that discussed above.

In this case, G_MSB produces a maximum signal amplitude less than V_pi in the example shown in FIG. 5, and G_LSB is approximately scaled by ⅓ of the maximum MSB value. The optical modulator 30B can be DC-biased at the point corresponding to P(0,0) as needed. This produces relative optical outputs of P(0,1)=d (i.e., the lowest output power), P(0,0)=d+⅓, P(1,1)=d+⅔, and P(1,0)=d+1, as shown in FIG. 6. The transfer function shown in FIG. 6 provides a type of non-standard PAM-4 output, as shown above in Table 2.

In other configurations, the phase shifter 34D in the first modulator arm 33D of the RF modulation system 10D can be designed to apply a phase shift in a different, and opposite, direction as compared to the phase shifter 36D in the second modulator arm 35D. That arrangement has the effect of causing the voltage-induced phases among the modulator arms 33D and 35D to add rather than subtract, when the carrier signals interfere in the RF combiner 38D to produce the output.

FIG. 8 illustrates an example transfer function of output power versus relative phase shift for the RF modulation system 10D when the phase shifts of the first and second modulator arms 33 and 35 are different, and opposite, as compared to each other. In this case, G_MSB again produces a maximum signal amplitude less than V_pi in the example shown in FIG. 5, and G_LSB is approximately scaled by ⅓ of the maximum MSB value. This produces relative outputs of P(0,0)=d, P(0,1)=d+⅓, P(1,0)=d+⅔, and P(1,1)=d+1, as shown in FIG. 8. The level “d” is again considered to be the lowest or “zero” level of the PAM-4 output optical signal. The transfer function shown in FIG. 8 provides a type of non-gray-code, non-standard PAM4 output, as shown above in Table 3.

All the configurations described herein can be achieved using limiting amplifiers to drive the MSB and LSB, so that the linearity of the amplifiers is not a major driver of the design. It can also be useful in some cases to have the MSB and LSB drive amplitudes that are adjustable to obtain good eye-openings, and adjustable drive amplitudes or gains of the drivers 14A and 14B is within the scope of the embodiments. Equalization of the drive amplifier output may be required to compensate for frequency response of the modulator in some cases. The linearity requirements of the amplifiers are significantly reduced based on the concepts described herein in any case. The concepts described herein also do not rely upon the electrical generation of a multi-level PAM4 driver signal to drive the modulator.

The modulated carrier signals generated by the modulation systems described herein can be received by a receiver and demodulated by a demodulator. The embodiments thus encompass communications systems including modulators, transmitters, receivers, and demodulators. An example coherent PAM demodulator can rely upon a synchronized clock and a matched reference pulse to detect the amplitude of each received PAM pulse. A non-coherent PAM demodulator can rely upon envelope detection or sample-and-hold techniques to approximate the amplitude of each received PAM pulse. An example PAM demodulator includes an input filter, a synchronization or clock recovery circuit to align sampling, a sample-and-hold circuit that measures or samples the amplitude of each pulse at the correct timing, and a decision device that maps the sampled amplitudes to PAM levels. The PAM demodulator can also include an equalizer to correct inter-symbol interference caused by bandwidth limitations in the communications medium 40.

The drivers, driver amplifiers, and related circuitry can be implemented by a range of different types of transistors formed in a range of different semiconductor materials. The transistors can be formed as bipolar junction transistors, FETs, variants thereof, and other types of transistors, and the concepts can be applied to a range of transistor types. Among other types of FET transistors, the transistors described herein can be formed as high-electron mobility transistors (HEMTs), pseudomorphic high-electron mobility transistors (pHEMTs), metamorphic high-electron mobility transistors (mHEMTs), and other types of transistors. The FETs can include metal oxide or insulator semiconductor (MOSFET or MISFET) transistors and metal-semiconductor field-effect transistor (MESFETs). The transistors can include one or more field plates, such as source-connected field plates, gate-connected field plates, or both source-connected and gate-connected field plates. The transistors can be implemented in silicon germanium (SiGe), gallium arsenide (GaAs), gallium nitride (GaN), GaN materials, indium phosphide (InP) and other semiconductor materials on or over a range of different substrates. As non-limiting examples, the transistors can be structured as enhancement or depletion mode FET transistors, such as a depletion mode GaAs pHEMT transistors, as GaN HEMT transistors, as GaN materials HEMT transistors, or as related power transistors.

The transistors and other active devices described herein can be formed using group III-V semiconductor materials and semiconductor manufacturing processes. The group III elemental materials include scandium (Sc), aluminum (Al), gallium (Ga), and indium (In), and the group V elemental materials include nitrogen (N), phosphorus (P), arsenic (As), and antimony (Sb)). Thus, in some examples, the concepts can be applied to group III-V active semiconductor devices, such as the III-Nitrides (aluminum (Al)-, gallium (Ga)-, indium (In)-, and alloys (AlGaIn)-based Nitrides), GaAs, InP, InGaP, AlGaAs, etc. devices. However, the concepts may be applied to transistors and other active devices formed from other semiconductor materials.

The concepts described herein can be embodied by GaN-on-Si transistors and devices, GaN-on-SiC transistors and devices, as well as other types of semiconductor materials. As used herein, the phrase “gallium nitride material(s)” or “GaN material(s)” refers to gallium nitride and any of its alloys, such as aluminum gallium nitride (AlₓGa₍₁₋ₓ₎N), indium gallium nitride (In_{y}Ga_{(1-y)}N), aluminum indium gallium nitride (AlₓIn_{y}Ga_{(1-x-y)}N), gallium arsenide phosphide nitride (GaAsₐP_{b}N_{(1-a-b)}), aluminum indium gallium arsenide phosphide nitride (AlₓIn_{y}Ga_{(1-x-y)}AsₐP_{b}N_{(1-a-b)}), among others. Typically, when present, arsenic and/or phosphorous are at low concentrations (e.g., less than 5 weight percent). The gallium nitride materials can be n-type doped, p-type doped, or unintentionally doped (UID). The term “gallium nitride” or “GaN” refers directly to gallium nitride, exclusive of its alloys (i.e., x=y=a=b=0). The GaN can be n-type doped, p-type doped, or unintentionally doped (UID).

In view of the limitations of the semiconductor manufacturing and processing techniques available in the field, the terms “approximately” and “about” reflect a certain inability (or uncertainty) to precisely control the exact dimensions of certain features described herein. Depending on the level of precision that can be achieved using the commercially available semiconductor processing tools available at the time, the terms “approximately” and “about” may be used to mean within ±20% of a target value for some features, within +10% of a target value for some features, within ±5% of a target value for some features, and within +2% of a target value for some features. The terms “approximately” and “about” may include the target value.

The concepts described herein can be combined in one or more embodiments in any suitable manner, and the features discussed in the embodiments are interchangeable in some cases. Example embodiments are described herein, although a person of skill in the art will appreciate that the technical solutions and concepts can be practiced in some cases without all the specific details of each example. Additionally, substitute or equivalent steps, components, materials, and the like may be employed. It should also be appreciated that some well-known process steps, semiconductor material layers, semiconductor device features, and other features have been omitted to avoid obscuring the concepts.

Although relative terms such as “on,” “below,” “upper,” “lower,” “top,” “bottom,” “right,” and “left” may be used to describe the relative spatial relationships of certain structural features, these terms are used for convenience only, as a direction in the examples. Thus, if a structure is turned upside down, the “upper” component will become a “lower” component. When a structure or feature is described as being “on” (or formed on) another structure or feature, the structure can be positioned directly on (i.e., contacting) the other structure, without any other structures or features intervening between the structure and the other structure. When a structure or feature is described as being “over” (or formed over) another structure or feature, the structure can be positioned over the other structure, with or without other structures or features intervening between them. When two components are described as being “coupled to” each other, the components can be electrically coupled to each other, with or without other components being electrically coupled and intervening between them. When two components are described as being “directly coupled to” each other, the components can be electrically coupled to each other, without other components being electrically coupled between them.

Terms such as “a,” “an,” “the,” and “said” are used to indicate the presence of one or more elements and components. The terms “comprise,” “include,” “have,” “contain,” and their variants are used to be open ended and may include or encompass additional elements, components, etc., in addition to the listed elements, components, etc., unless otherwise specified. The terms “first,” “second,” etc. may be used as differentiating identifiers of individual or respective components among a group thereof, rather than as a descriptor of a number of the components, unless clearly indicated otherwise.

Although embodiments have been described herein in detail, the descriptions are by way of example. The features of the embodiments described herein are representative and, in alternative embodiments, certain features and elements can be added or omitted. Additionally, modifications to aspects of the embodiments described herein can be made by those skilled in the art without departing from the spirit and scope of the present invention defined in the following claims, the scope of which are to be accorded the broadest interpretation so as to encompass modifications and equivalent structures.

Therefore, the following is claimed:

1. A modulator system comprising:
a generator configured to generate a carrier wave;
a modulator coupled to the generator and comprising a first modulator arm and a second modulator arm; and
a driver configured to:
generate a first bias control signal for phase modulation of the carrier wave in the first modulator arm based on a more significant bit of a data signal; and
generate a second bias control signal for modulation of the carrier wave in the second modulator arm based on a less significant bit of the data signal.

2. The modulator system according to claim 1, wherein the driver comprises:
a first driver configured to generate the first bias control signal for modulation of the carrier wave in the first modulator arm based on the more significant bit of a data signal; and
a second driver configured to generate the second bias control signal for modulation of the carrier wave in the second modulator arm based on the less significant bit of the data signal.

3. The modulator system according to claim 2, wherein a gain of the second driver is a fraction of a gain of the first driver.

4. The modulator system according to claim 2, wherein a gain of the second driver is ⅓ of a gain of the first driver.

5. The modulator system according to claim 1, wherein the modulator comprises a first phase shifter in the first modulator arm and a second phase shifter in the second modulator arm.

6. The modulator system according to claim 5, wherein:
the modulator comprises an optical modulator;
the first modulator arm and the second modulator arm comprise materials capable of altering refractive indexes based on changing electric fields; and
an electric field induced by the first phase shifter based on the first bias control signal is co-linear and in a same direction as an electric field induced by the second phase shifter based on the second bias control signal.

7. The modulator system according to claim 5, wherein:
the modulator comprises an optical modulator;
the first modulator arm and the second modulator arm comprise materials capable of altering refractive indexes based on changing electric fields; and
an electric field induced by the first phase shifter based on the first bias control signal is in a different direction as compared to an electric field induced by the second phase shifter based on the second bias control signal.

8. The modulator system according to claim 5, wherein:
the modulator comprises a radio frequency (RF) modulator;
the first modulator arm and the second modulator arm comprise a pair of parallel-extending microstrip transmission lines; and
the first phase shifter and the second phase shifter have a same polarity.

9. The modulator system according to claim 5, wherein:
the modulator comprises a radio frequency (RF) modulator;
the first modulator arm and the second modulator arm comprise a pair of parallel-extending microstrip transmission lines; and
the first phase shifter and the second phase shifter have different polarities.

10. The modulator system according to claim 1, wherein the modulator is configured to modulate the carrier wave for PAM-4 modulation.

11. A modulator system comprising:
a generator configured to generate a carrier wave;
a modulator coupled to the generator and comprising a first modulator arm and a second modulator arm;
a first driver that receives a more significant bit of a data signal and is configured to generate a first bias control signal for phase modulation of the carrier wave in the first modulator arm; and
a second driver that receives a less significant bit of the data signal and is configured to generate a second bias control signal for phase modulation of the carrier wave in the second modulator arm.

12. The modulator system according to claim 11, wherein a gain of the second driver is a fraction of a gain of the first driver.

13. The modulator system according to claim 11, wherein the modulator comprises a first phase shifter in the first modulator arm and a second phase shifter in the second modulator arm.

14. The modulator system according to claim 13, wherein:
the modulator comprises an optical modulator;
the first modulator arm and the second modulator arm comprise materials capable of altering refractive indexes based on changing electric fields;
the first phase shifter comprises a first electrode positioned along the first modulator arm; and
the second phase shifter comprises a second electrode positioned along the second modulator arm.

15. The modulator system according to claim 13, wherein an electric field induced by the first phase shifter based on the first bias control signal is co-linear and in a same direction as an electric field induced by the second phase shifter based on the second bias control signal.

16. The modulator system according to claim 13, wherein an electric field induced by the first phase shifter based on the first bias control signal is in a different direction as compared to an electric field induced by the second phase shifter based on the second bias control signal.

17. The modulator system according to claim 13, wherein:
the modulator comprises a radio frequency (RF) modulator;
the first modulator arm and the second modulator arm comprise a pair of parallel-extending microstrip transmission lines;
the first phase shifter comprises at least one first switching device having a variable capacitance electrically coupled along the first modulator arm; and
the second phase shifter comprises at least one second switching device having a variable capacitance electrically coupled along the second modulator arm.

18. A modulator system comprising:
a generator configured to generate a carrier wave;
a modulator coupled to the generator and comprising a first modulator arm and a second modulator arm, wherein:
the carrier wave is phase shifted in the first modulator arm based on a more significant bit of a data signal; and
the carrier wave is phase shifted in the second modulator arm based on a less significant bit of a data signal.

19. The modulator system according to claim 18, wherein a phase shift for a logic true of the more significant bit in the first modulator arm is greater than a phase shift for a logic true of the less significant bit in the second modulator arm.

20. The modulator system according to claim 18, wherein a phase shift for a logic true of the less significant bit in the second modulator arm is ⅓ of a phase shift for a logic true of the more significant bit in the first modulator arm.
